(19) United States
(12) Patent Application Publication
(10) Pub. No.: US 2010/0259507 A1
(43) Pub. Date: Oct. 14, 2010

(54) OPTICAL TOUCH APPARATUS AND OPERATING METHOD THEREOF

(76) Inventors: Meng-Shin Yen, Taipei City (TW); William Wang, Taoyuan City (TW); Chung-Cheng Chou, Lujhu Township (TW)

Correspondence Address: PATTERSON & SHERIDAN, LLP - - - IPTEC, 3040 Post Oak Boulevard, Suite 1500, Houston, TX, 77056-6582, US

(21) Appl. No.: 12/718,643

(22) Filed: Mar. 5, 2010

(30) Foreign Application Priority Data
Apr. 9, 2009 (TW) 098111824

(51) Int. Cl. G06F 3/042

(52) U.S. Cl. 345/175

(57) ABSTRACT

An optical touch apparatus and operating method thereof are disclosed. The optical touch apparatus comprises an optical module, a light sensing module, and a processing module. The optical module and the light sensing module are set at a first side and an opposite second side of a surface of the optical touch apparatus respectively. The optical module receives a light source and uniformly emits a plurality of lights. When at least one of the plurality of lights is blocked by an object above the surface, the light sensing module generates a sensing result based on the condition of receiving the plurality of lights. The processing module determines a touch point location corresponding to the object on the surface based on the sensing result.

### BACKGROUND OF THE INVENTION

1. Field of the Invention

The present invention relates to a touch apparatus, and more particularly, to an optical touch apparatus capable of sensing touch points easily through a light guiding apparatus and a photoelectric sensing apparatus and operating method thereof.

2. Description of the Prior Art

Recently, with the developing of image display related technology, there are various new types of display apparatus shown on the market to replace the conventional CRT monitor gradually. Wherein, the touch liquid crystal display has advantages such as power saving, smaller size, and inputting by touching directly, therefore, the touch liquid crystal display is popular to the ordinary consumers and becomes the main stream of the display market. The touch liquid crystal display is widely used in various types of electronic products, for example, an Automated Teller Machine (ATM), a point-of-sale (POS) terminal, a visitor navigation system, or an industrial controlling system.

In general, the current touch apparatus, such as a resistance touch apparatus, a capacitance touch apparatus, and an optical touch apparatus, can detect one touch point or more touch points through different detection theorems or ways. In the various types of touch apparatus mentioned above, because the optical touch apparatus has a characteristic of good transmittance; it has become another well-used technology different from the resistance touch apparatus and the capacitance touch apparatus.

However, the current optical touch apparatus still has many problems. Because a lot of light emitters and light receivers are necessary to be set around the panel of the conventional optical touch apparatus to detect touch points, the cost of manufacturing the optical touch apparatus will be higher, and the optical touch apparatus can not achieve the touch detection with high resolution, therefore, the application of the optical touch apparatus will be seriously limited. Recently, the triangulation measurement method is applied to the optical touch technology to detect the touch points. In this way, the touch inputting resolution can be enhanced and the amount of the light emitters and the light receivers can be reduced, however, some new problems such as complicated calculations and the reflector of the border should be positioned precisely are needed to be solved.

Therefore, the invention provides an optical touch apparatus and operating method thereof to solve the aforementioned problems.

### SUMMARY OF THE INVENTION

The invention provides an optical touch apparatus capable of sensing touch points easily through a light guiding apparatus and photoelectric sensing apparatus and operating method thereof.

The first embodiment of the invention is an optical touch apparatus. In this embodiment, the optical touch apparatus includes an optical module, a light sensing module, and a processing module. Wherein, the optical module and the light sensing module are set at a first side of a surface of the optical touch apparatus and a second side opposite to the first side respectively; the light sensing module is coupled to the processing module. The optical module receives a light source and uniformly emits a plurality of lights. When at least one of the plurality of lights is blocked by an object above the surface, the light sensing module will generate a sensing result based on the condition of receiving the plurality of lights. The processing module determines a touch point location corresponding to the object on the surface based on the sensing result.

The second embodiment of the invention is an optical touch apparatus operating method. In this embodiment, the optical touch apparatus includes a first optical module, a first light sensing module, and a processing module. The first optical module and the first light sensing module are set at a first side of a surface of the optical touch apparatus and a second side opposite to the first side respectively.

In this method, at first, the first optical module receives a first light source and uniformly emits a plurality of first direction lights. When at least one of the plurality of first direction lights is blocked by an object above the surface, the first light sensing module will generate a first sensing result based on the condition of receiving the plurality of first direction lights. The processing module determines a touch point location corresponding to the object on the surface based on the first sensing result.

Compared with the prior arts, the optical touch apparatus and operating method of the invention can easily achieve the touch detection with high resolution through simple optical devices such as a light guiding apparatus and a photoelectric sensing apparatus. Therefore, not only the cost of setting a lot of light emitters and light receivers in the prior art can be largely reduced, but also problems such as complicated calculations and the reflector of the border should be positioned precisely caused by detecting the touch points via the triangulation measurement method can be also prevented.

The objective of the present invention will no doubt become obvious to those of ordinary skill in the art after reading the following detailed description of the preferred embodiment, which is illustrated in the various figures and drawings.

BRIEF DESCRIPTION OF THE APPENDED DRAWINGS

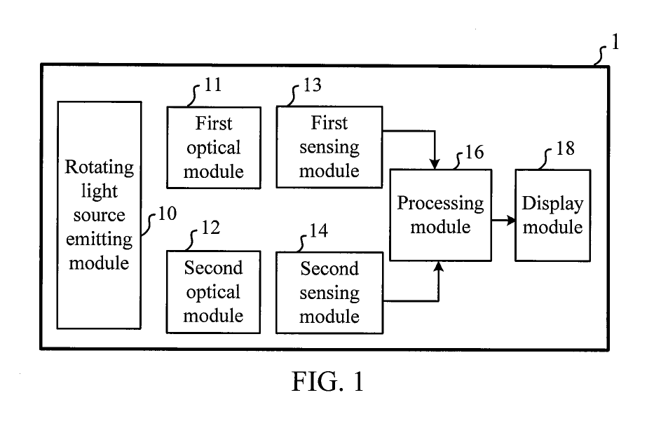

FIG. 1 illustrates a function block diagram of the optical touch apparatus of the first embodiment in the invention.

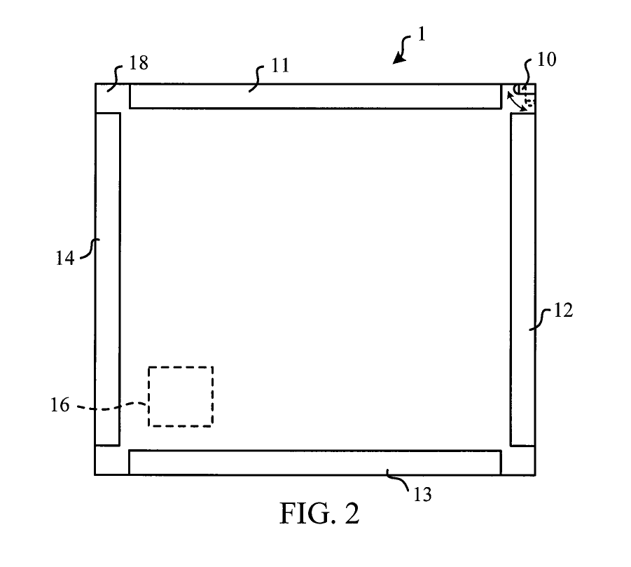

FIG. 2 illustrates a scheme diagram of the optical touch apparatus of the first embodiment in the invention.

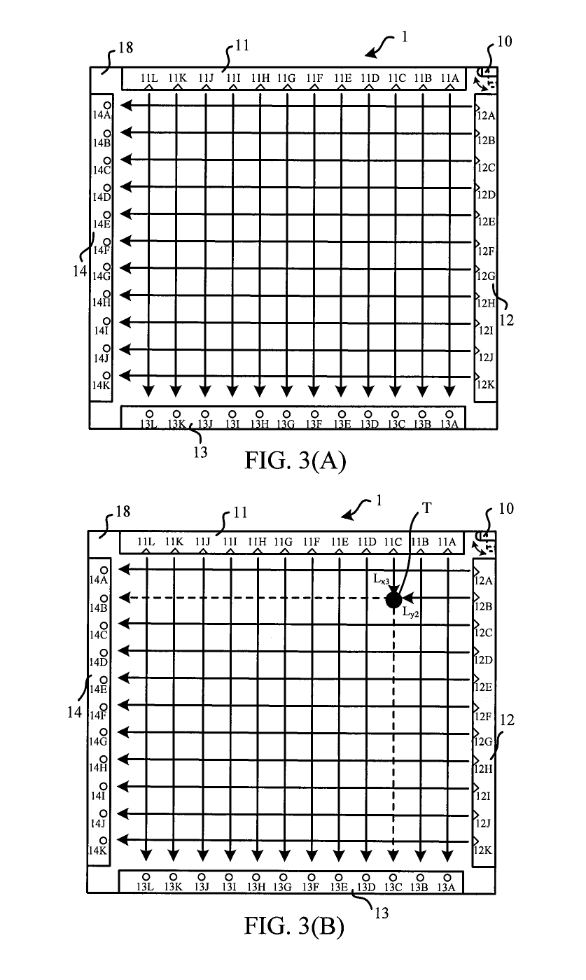

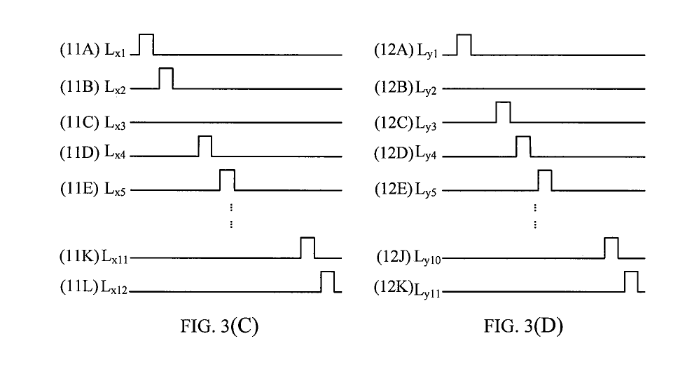

FIG. 3(A) illustrates a scheme diagram of operating the optical touch apparatus under the condition of no touch points.

FIG. 3(B) illustrates an example of the optical touch apparatus detecting touch points.

FIG. 3(C) and FIG. 3(D) illustrate scheme diagrams of the first light sensing module receiving the plurality of first direction lights and the second light sensing module receiving the plurality of second direction lights respectively.

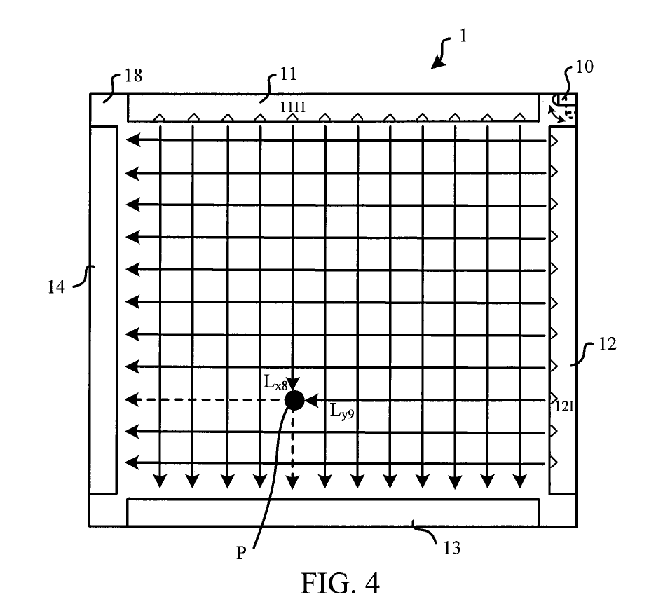

FIG. 4 illustrates another example of the optical touch apparatus detecting touch points.

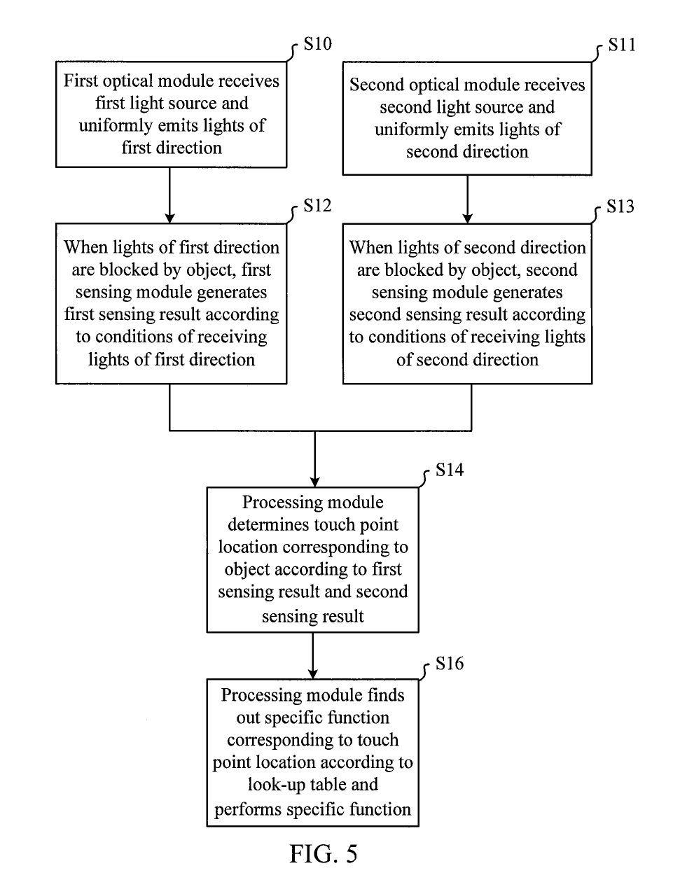

FIG. 5 illustrates a flowchart of the optical touch apparatus operating method of the second embodiment in the invention.

### DETAILED DESCRIPTION OF THE INVENTION

The invention provides an optical touch apparatus and operating method thereof. Since the optical touch apparatus can easily achieve the touch point detection with high resolution via simple optical devices such as a light guiding apparatus and a photoelectric sensing apparatus, not only the cost of setting a lot of light emitters and light receivers in the prior art can be largely reduced, but also the complicated calculations caused by detecting the touch points via the triangulation measurement method can be also prevented. Therefore, the efficiency of detecting touch points can be enhanced and the manufacturing cost can be also reduced.

A first embodiment of the invention is an optical touch apparatus. In this embodiment, the optical touch apparatus can be applied to a LCD apparatus or other display apparatuses and have the functions of displaying screen and touch inputting. Please refer to FIG. 1 and FIG. 2, FIG. 1 and FIG. 2 show the function block diagram and the scheme diagram of the optical touch apparatus respectively.

As shown in FIG. 1 and FIG. 2, the optical touch apparatus 1 includes a rotational light source emitting module 10, a first optical module 11, a second optical module 12, a first light sensing module 13, a second light sensing module 14, a processing module 16, and a display module 18. Wherein, the first optical module 11 and the first light sensing module 13 are set at a first side and a second side of a surface of the display module 18 respectively, and the second side is opposite to the first side; the second optical module 12 and the second light sensing module 14 are set at a third side and a fourth side of the surface of the display module 18 respectively, and the fourth side is opposite to the third side; the first light sensing module 13 and the second light sensing module 14 are both coupled to the processing module 16; the processing module 16 is coupled to the display module 18.

Next, the above-mentioned modules of the optical touch apparatus 1 will be introduced in detail. At first, the rotational light source emitting module 10 is used to provide the light source needed when the optical touch apparatus 1 detects touch points. The rotational light source emitting module 10 emits lights to the first optical module 11 and the second optical module 12 through a rotation way.

In practical applications, the light source needed when the optical touch apparatus 1 detects the touch points can be provided by the rotational light source emitting module 10, or two different light source emitting modules can provide light sources to the first optical module 11 and the second optical module 12 respectively. The advantage of using the rotational light source emitting module 10 in this embodiment is to reduce the number of the light source emitting module, so that the cost and space of setting the light source emitting modules can be effectively reduced.

In order to achieve the best effect of saving cost and space, in fact, the optical touch apparatus 1 can even use the back light source of the display module 18 directly as the light source needed when the optical touch apparatus 1 detects touch points. By doing so, it is unnecessary to set the rotational light source emitting module 10 in the optical touch apparatus 1. There are no limitations to the type of the light source emitted from the rotational light source emitting module 10; it can be any types of light source.

When the first optical module 11 receives the light source emitted from the rotational light source emitting module 10, the first optical module 11 will uniformly emit a plurality of parallel first direction lights. Similarly, when the second optical module 12 receives the light source emitted from the rotational light source emitting module 10, the second optical module 12 will uniformly emit a plurality of parallel second direction lights. In fact, the plurality of first direction lights is vertical to the plurality of second direction lights.

In this embodiment, the first optical module 11 and the second optical module 12 are light guiding apparatuses (e.g., light guiding plate) with light-guiding function; the first optical module 11 and the second optical module 12 include a plurality of light guiding units respectively. Please refer to FIG. 3(A). FIG. 3(A) illustrates a scheme diagram of operating the optical touch apparatus 1 under the condition of no touch points. As shown in FIG. 3(A), the first optical module 11 totally includes twelve first light guiding units 11A˜11L from right to left; the second optical module 12 totally includes eleven second light guiding units 12A˜12K from up to down.

Wherein, the first light guiding units 11A˜11L of the first optical module 11 emit the parallel first direction lights Lₓ₁˜Lₓ₁₂, that is to say, the first light guiding unit 11A emits the first direction light Lₓ₁; the first light guiding unit 11B emits the first direction light Lₓ₂; . . . ; the first light guiding unit 11K emits the first direction light Lₓ₁₁; the first light guiding unit 11L emits the first direction light Lₓ₁₂. In fact, the first direction lights Lₓ₁˜Lₓ₁₂ emitted from the first optical module 11 are all vertical or approximately vertical to the direction that the light source emitting into the first optical module 11. Similarly, the second light guiding units 12A˜12K of the second optical module 12 emit the parallel second direction lights L_{y1˜L}_{y11},that is to say, the second light guiding unit 12A emits the second direction light L_{y1}; the second light guiding unit 12B emits the second direction light L_{y2}; . . . ; the second light guiding unit 12J emits the second direction light L_{y10}; the second light guiding unit 12K emits the second direction light L_{y11}. In fact, the second direction lights L_{y1}˜L_{y11} emitted from the second optical module 12 are all vertical or approximately vertical to the direction that the light source emitting into the second optical module 12.

Since FIG. 3(A) shows the condition of no touch points, at this time, the first light sensing module 13 can receive all of the first direction lights Lₓ₁˜Lₓ₁₂ emitted from the first optical module 11, and the second light sensing module 14 can also receive all of the second direction lights L_{y1}˜L_{y11} emitted from the second optical module 12. In practical applications, the first light sensing module 13 totally includes twelve first photoelectric sensing units 13A˜13L from right to left, wherein the first photoelectric sensing units 13A corresponds to the first light guiding unit 11A of the first optical module 11 and the horizontal axial coordinate X₁, and the first photoelectric sensing units 13A is used to receive the first direction light Lₓ₁ emitted from the first light guiding unit 11A; the first photoelectric sensing units 13B corresponds to the first light guiding unit 11B of the first optical module 11 and the horizontal axial coordinate X₂, and the first photoelectric sensing units 13B is used to receive the first direction light Lₓ₂ emitted from the first light guiding unit 11B, and so on. In fact, the corresponding relationships among the first photoelectric sensing units, the first light guiding units, and the horizontal axial coordinate mentioned above can be stored in the default look-up table to be retrieved by the processing module 16.

Similarly, the second light sensing module 14 totally includes eleven second photoelectric sensing units 14A˜14K from up to down, wherein, the second photoelectric sensing unit 14A corresponds to the second light guiding unit 12A of the second optical module 12 and the vertical axial coordinate Y₁, and the second photoelectric sensing unit 14A is used to receive the second direction light L_{y1} emitted from the second light guiding unit 12A; the second photoelectric sensing unit 14B corresponds to the second light guiding unit 12B of the second optical module 12 and the vertical axial coordinate Y₂, and the second photoelectric sensing unit 14B is used to receive the second direction light L_{y2} emitted from the second light guiding unit 12B, and so on. In fact, the corresponding relationships among the second photoelectric sensing units, the second light guiding units, and the vertical axial coordinate mentioned above can be stored in the default look-up table to be retrieved by the processing module 16.

It should be noticed that the emitting and receiving modes of the first optical module 11 and the first light sensing module 13 can be divided into 3 types as follows: (1) if the first light guiding units 11A˜11L of the first optical module 11 emit the first direction lights Lₓ₁˜Lₓ₁₂ sequentially, the first light sensing module 13 can receive the first direction lights Lₓ₁˜Lₓ₁₂ simultaneously; (2) if the first light guiding units 11A˜11L of the first optical module 11 emit the first direction lights Lₓ₁˜Lₓ₁₂ simultaneously, the first light sensing module 13 can receive the first direction lights Lₓ₁˜Lₓ₁₂ sequentially; (3) if the first light guiding units 11A˜11L of the first optical module 11 emit the first direction lights Lₓ₁˜Lₓ₁₂ sequentially, the first light sensing module 13 can also receive the first direction lights Lₓ₁˜Lₓ₁₂ sequentially. Since the emitting and receiving modes of the second optical module 12 and the second light sensing module 14 are similar to those of the first optical module 11 and the first light sensing module 13, they are not described again here.

In practical applications, the first light sensing module 13 and the second light sensing module 14 can be replaced by two optical modules (e.g., the light guiding plates), the two optical modules sequentially receive the first direction light and the second direction light respectively, at this time, a large-angle photoelectric sensor (not shown in the figure) is necessary to be set at the corners formed by the second side and the fourth side of the display module 18 to generate the first sensing result and the second sensing result based on the conditions of the two optical modules sequentially receiving the lights respectively, and the processing module 16 will determine the touch point position based on the first sensing result and the second sensing result.

Then, how the optical touch apparatus 1 detects touch points through the first optical module 11, the second optical module 12, the first light sensing module 13, and the second light sensing module 14 will be introduced. Please refer to FIG. 3(B). FIG. 3(B) illustrates an example of the optical touch apparatus detecting touch points. As shown in FIG. 3(B), a touch point T is shown on the surface of the display module 18. In fact, the touch point T can be formed by any objects without any limitations, such as fingers or touch pens. Even the object forming the touch point T does not have to touch the surface of the display module 18, if the object can block the lights transmitted above the surface of the display module 18, the optical touch apparatus 1 can detect the touch point T to determine the position coordinate of the touch point T on the surface.

Back to FIG. 3(B), since the position of the touch point T formed by the object blocks the first direction light Lₓ₃ emitted from the first light guiding unit 11C of the first optical module 11, therefore, the first photoelectric sensing unit 13C of the first light sensing module 13 corresponding to the first light guiding unit 11C can not receive the first direction light Lₓ₃, so the first photoelectric sensing unit 13C will send out an un-received signal. And, other first photoelectric sensing units 13A, 13B, and 13D˜13L of the first light sensing module 13 can receive the first direction lights Lₓ₁, Lₓ₂, and Lₓ₄˜Lₓ₁₂ respectively. The actual light receiving conditions of all first photoelectric sensing units 13A˜13L of the first light sensing module 13 mentioned above are shown as FIG. 3(C).

Then, the first light sensing module 13 will generate a first sensing result based on the actual conditions of the first photoelectric sensing units 13A˜13L receiving the first direction lights. In this example, since the first light sensing module 13 only receives the un-received signal transmitted by the first photoelectric sensing unit 13C, so that the first photoelectric sensing unit 13C will generate the first sensing result that the first photoelectric sensing unit 13C does not receive lights based on the un-received signal, and transmit the first sensing result to the processing module 16.

Similarly, as shown in FIG. 3(B), since the position of the touch point T formed by the object blocks the second direction light L_{y2} emitted from the second light guiding unit 12B of the second optical module 12, therefore, the second photoelectric sensing unit 14B of the second light sensing module 14 corresponding to the second light guiding unit 12B can not receive the second direction light L_{y2}, so the second photoelectric sensing unit 14B will send out an un-received signal. And, other second photoelectric sensing units 14A, and 14C˜14K of the second light sensing module 14 can receive the second direction lights L_{y1}, and L_{y3}˜L_{y11} respectively. The actual light receiving conditions of all second photoelectric sensing units 14A˜14K of the second light sensing module 14 mentioned above are shown as FIG. 3(D).

Next, the second light sensing module 14 will generate a second sensing result based on the actual conditions of receiving the second direction lights. In this example, since the second light sensing module 14 only receives the un-received signal transmitted by the second photoelectric sensing unit 14B, so that the second light sensing module 14 will generate the second sensing result that the second photoelectric sensing unit 14B does not receive lights based on the un-received signal, and transmit the second sensing result to the processing module 16.

Afterward, after the processing module 16 receives the first sensing result and the second sensing result from the first light sensing module 13 and the second light sensing module 14 respectively, the processing module 16 will get the information that the first photoelectric sensing unit 13C and the second photoelectric sensing unit 14B fail to receive lights based on the first sensing result and the second sensing result, and obtain the first light guiding unit 11C and the horizontal axial coordinate X₃ corresponding to the first photoelectric sensing unit 13C, and the second light guiding unit 12B and the vertical axial coordinate Y₂ corresponding to the second photoelectric sensing unit 14B based on the look-up table. Therefore, the processing module 16 can determine the two-dimensional coordinates (X₃, Y₂) of the touch point position formed by the object on the surface of the display module 18.

In practical applications, after the processing module 16 determines the coordinates (X₃, Y₂) of the touch point, the processing module 16 can further find out a specific function corresponding to the coordinates (X₃, Y₂) of the touch point according to another default look-up table. Then, the processing module 16 can perform the specific function and show it on the display module 18, so that the user can operate it. For example, the specific function can be click, open, confirm, play, zoom in, zoom out, scroll up, scroll down, scroll left, scroll right, move to the previous page, move to the next page, move to the previous tag, move to the next tag, or other displaying functions.

In fact, the display module 18 can be LCD panel or other display apparatuses without any limitations. Additionally, the processing module 16 and the display module 18 can be also coupled to a data processing apparatus (e.g., a computer). After the processing module 16 find out the specific function, the data processing apparatus will receive and perform the specific function, and display screen via the display module 18 for the user to operate it.

For example, please refer to FIG. 4. FIG. 4 shows the scheme diagram of the optical touch apparatus detecting the touch point P. As shown in FIG. 4, since the first light sensing module 13 fails to receive the first direction light Lₓ₈ emitted from the first light guiding unit 11H of the first optical module 11 and the second light sensing module 14 fails to receive the second direction light L_{y9} emitted from the second light guiding unit 12I of the second optical module 12, therefore, the processing module 16 will determine the two-dimensional coordinates (X₈, Y₉) of the touch point P formed by the object based on the first sensing result and the second sensing result transmitted from the first light sensing module 13 and the second light sensing module 14 respectively.

It is assumed that the optical touch apparatus 1 is applied to a notebook, and the position that a play key shown on the monitor of the notebook corresponds to the coordinates (X₈, Y₉), the optical touch apparatus 1 will determine that the user wants to push the play key to playback a video file, therefore, the notebook will perform the playback function of the play key based on the information provided by the optical touch apparatus 1.

In practical applications, if the volume of the object forming the touch point is larger, the first light sensing module 13 could fail to receive the first direction lights Lₓ₇ and Lₓ₈ emitted from two light guiding units (e.g., the first light guiding unit 11G and 11H) of the first optical module at the same time. When the processing module 16 receives the first sensing result transmitted from the first light sensing module 13, the processing module 16 will use any averaging method to calculate the two adjacent horizontal axial coordinates X7 and X8 to obtain the average horizontal axial coordinate corresponding to the touch point. And, the condition that the object blocking two or more lights can be deduced by analogy, so not described again here.

The second embodiment of the invention is an optical touch apparatus operating method. In this embodiment, the optical touch apparatus includes a first optical module, a second optical module, a first light sensing module, a second light sensing module, and a processing module. Wherein, the first optical module and the first light sensing module are set at a first side of a surface of the optical touch apparatus and a second side opposite to the first side respectively; the second optical module and the second light sensing module are set at a third side of the surface of the optical touch apparatus and a fourth side opposite to the third side respectively.

Please refer to FIG. 5. FIG. 5 illustrates a flowchart of the optical touch apparatus operating method. As shown in FIG. 5, in the optical touch apparatus operating method, at first, the steps S10 and S11 are performed, the first optical module and the second optical module receive a first light source and a second light source respectively, and uniformly emit a plurality of first direction lights and a plurality of second direction lights respectively.

In practical applications, the first light source and the second light source can be emitted from the same light source emitting apparatus, or emitted from two different light source emitting apparatuses, even the back light source of the optical touch apparatus can be directly used as the first light source and the second light source. And, the first optical module and the second optical module can be light guiding apparatuses (e.g., the light guiding plates) with light guiding function, and include a plurality of light guiding units respectively, to emit the plurality of first direction lights and the plurality of second direction lights respectively.

When at least one of the plurality of first direction lights is blocked by an object above the surface, the step S12 is performed, the first light sensing module will generate a first sensing result based on the condition of receiving the plurality of first direction lights. Similarly, when at least one of the plurality of second direction lights is blocked by the object above the surface, the step S13 is performed, the second light sensing module will generate a second sensing result based on the condition of receiving the plurality of second direction lights.

In this embodiment, the first optical module includes a plurality of first light guiding units; the first light sensing module includes a plurality of first photoelectric sensing units, a first photoelectric sensing unit of the plurality of first photoelectric sensing units corresponds to a first light guiding unit of the plurality of first light guiding units and a first position, and used to receive a first direction light emitted from the first light guiding unit. Similarly, the second optical module also includes a plurality of second light guiding units; the second light sensing module includes a plurality of second photoelectric sensing units, a second photoelectric sensing unit of the plurality of second photoelectric sensing units corresponds to a second light guiding unit of the plurality of second light guiding units and a second position, and used to receive a second direction light emitted from the second light guiding unit.

In practical applications, if the first optical module emits the plurality of first direction lights simultaneously, the first light sensing module will receive the plurality of first direction lights sequentially; if the first optical module emits the plurality of first direction lights sequentially, the first light sensing module will receive the plurality of first direction lights simultaneously or sequentially. And, the conditions of the second optical module and the second light sensing module are the same, so not described again here.

Then, the step S14 is performed, the processing module determines a touch point location corresponding to the object on the surface based on the first sensing result and the second sensing result. In this embodiment, obviously, the touch point location can be a two-dimensional position coordinates (X, Y), wherein the horizontal axial coordinate X and the vertical axial coordinate Y are determined by the first sensing result and the second sensing result respectively. Afterward, the step S16 can be performed; the processing module finds out a specific function corresponding to the touch point position based on the look-up table and performs the specific function.

In practical applications, the first light sensing module and the second light sensing module can be replaced by two optical modules (e.g., the light guiding plates), the two optical modules sequentially receive the first direction light and the second direction light respectively, at this time, a large-angle photoelectric sensor is necessary to be set at the corners formed by the second side and the fourth side of the display module to generate the first sensing result and the second sensing result based on the conditions of the two optical modules sequentially receiving the lights respectively, and the processing module will determine the touch point position based on the first sensing result and the second sensing result.

Above all, since the optical touch apparatus and operating method thereof disclosed by the invention can easily achieve the touch point detection with high resolution via simple optical devices such as a light guiding apparatus and a photoelectric sensing apparatus, not only the cost of setting a lot of light emitters and light receivers in the prior art can be largely reduced, but also the complicated calculations caused by detecting the touch points via the triangulation measurement method can be also prevented. Additionally, the light source needed when the optical touch apparatus detects touch points can be provided by the original back light source, so that the design of the optical touch apparatus can be simplified and the cost can be also reduced. In the future, the invention can further applied to the multi-touch area.

Therefore, the optical touch apparatus and operating method thereof disclosed by the invention can effectively enhance the touch points detecting efficiency and reduce the manufacturing cost to increase the competitiveness of the optical touch apparatus on the market.

Although the present invention has been illustrated and described with reference to the preferred embodiment thereof, it should be understood that it is in no way limited to the details of such embodiment but is capable of numerous modifications within the scope of the appended claims.

What is claimed is:

1. An optical touch apparatus, comprising:
a first optical module, set at a first side on a surface of the optical touch apparatus, for receiving a first light source and uniformly emitting a plurality of first direction lights;
a first light sensing module, set at a second side opposite to the first side on the surface, when at least one of the plurality of first direction lights is blocked by an object above the surface, the first light sensing module generating a first sensing result based on the condition of receiving the plurality of first direction lights; and
a processing module, coupled to the first light sensing module, for determining a touch point location corresponding to the object on the surface based on the first sensing result.

2. The optical touch apparatus of claim 1, wherein the first optical module comprises a plurality of light guiding units, the first light sensing module comprises a plurality of photoelectric sensing units, a first photoelectric sensing unit of the plurality of photoelectric sensing units corresponds to a first light guiding unit of the plurality of light guiding units and a first position, and the first photoelectric sensing unit is used to receive a first direction light emitted from the first light guiding unit.

3. The optical touch apparatus of claim 2, wherein when the first direction light emitted from the first light guiding unit is blocked by the object, the first photoelectric sensing unit will send out an un-received signal, the first light sensing module generates the first sensing result according to the un-received signal and the first position corresponding to the first photoelectric sensing unit.

4. The optical touch apparatus of claim 1, wherein if the first optical module emits the plurality of first direction lights sequentially, the first light sensing module will receive the plurality of first direction lights simultaneously or sequentially.

5. The optical touch apparatus of claim 1, wherein if the first optical module emits the plurality of first direction lights simultaneously, the first light sensing module will receive the plurality of first direction lights sequentially.

6. The optical touch apparatus of claim 1, further comprising a light source emitting module used for emitting the first light source.

7. The optical touch apparatus of claim 1, wherein after the processing module determines the touch point location, the processing module will find out a specific function corresponding to the touch point location based on a look-up table, and perform the specific function.

8. The optical touch apparatus of claim 1, further comprising:
a second optical module, set at a third side on the surface, for receiving a second light source and uniformly emitting a plurality of second direction lights; and
a second light sensing module, set at a fourth side opposite to the third side on the surface and coupled to the processing module, when at least one of the plurality of second direction lights is blocked by the object above the surface, the second light sensing module generating a second sensing result based on the condition of receiving the plurality of second direction lights, the processing module determining the touch point location corresponding to the object on the surface based on the first sensing result and the second sensing result.

9. The optical touch apparatus of claim 8, further comprising a rotational light emitting module used for emitting the first light source and the second light source to the first optical module and the second optical module respectively.

10. The optical touch apparatus of claim 1, wherein the first optical module comprises a plurality of light guiding units, the plurality of light guiding units is used for emitting the plurality of first direction lights to the first light sensing module.

11. The optical touch apparatus of claim 1, wherein the first light sensing module comprises a plurality of photoelectric sensing units, the plurality of photoelectric sensing units is used for receiving the plurality of first direction lights emitted from the first optical module respectively.

12. A method of operating an optical touch apparatus, the optical touch apparatus comprising a first optical module, a first light sensing module, and a processing module, the first optical module being set at a first side on a surface of the optical touch apparatus, the first light sensing module being set at a second side opposite to the first side on the surface, the method comprising the steps of:
the first optical module receiving a first light source and uniformly emitting a plurality of first direction lights;
when at least one of the plurality of first direction lights is blocked by an object above the surface, the first light sensing module generating a first sensing result based on the condition of receiving the plurality of first direction lights; and
the processing module determining a touch point location corresponding to the object on the surface based on the first sensing result.

13. The method of claim 12, wherein the first optical module comprises a plurality of light guiding units, the first light sensing module comprises a plurality of photoelectric sensing units, a first photoelectric sensing unit of the plurality of photoelectric sensing units corresponds to a first light guiding unit of the plurality of light guiding units and a first position, and the first photoelectric sensing unit is used to receive a first direction light emitted from the first light guiding unit.

14. The method of claim 13, wherein when the first direction light emitted from the first light guiding unit is blocked by the object, the first photoelectric sensing unit will send out an un-received signal, the first light sensing module generates the first sensing result according to the un-received signal and the first position corresponding to the first photoelectric sensing unit.

15. The method of claim 12, wherein if the first optical module emits the plurality of first direction lights sequentially, the first light sensing module will receive the plurality of first direction lights simultaneously or sequentially.

16. The method of claim 12, wherein if the first optical module emits the plurality of first direction lights simultaneously, the first light sensing module will receive the plurality of first direction lights sequentially.

17. The method of claim 12, wherein the optical touch apparatus further comprises a second optical module and a second light sensing module, the second optical module is set at a third side on the surface and the second light sensing module is set at a fourth side opposite to the third side on the surface, the method further comprises the steps of:
the second optical module receiving a second light source and uniformly emitting a plurality of second direction lights;
when at least one of the plurality of second direction lights is blocked by the object above the surface, the second light sensing module generating a second sensing result based on the condition of receiving the plurality of second direction lights; and
the processing module determining the touch point location corresponding to the object on the surface based on the first sensing result and the second sensing result.

18. An optical touch apparatus, comprising:
a first optical module, set at a first side on a surface of the optical touch apparatus, for receiving a first light source and uniformly emitting a plurality of first direction lights;
a second optical module, set at a second side opposite to the first side on the surface, for receiving the plurality of first direction lights;
a photoelectric sensing module, when at least one of the plurality of first direction lights is blocked by an object above the surface, the photoelectric sensing module generating a first sensing result based on the condition of the second optical module receiving the plurality of first direction lights; and
a processing module, coupled to the photoelectric sensing module, for determining a touch point location corresponding to the object on the surface based on the first sensing result.

19. The optical touch apparatus of claim 18, wherein the photoelectric sensing module is a large-angle photoelectric sensing apparatus.

20. The optical touch apparatus of claim 18, wherein if the first optical module emits the plurality of first direction lights sequentially, the second optical module will receive the plurality of first direction lights simultaneously or sequentially.

21. The optical touch apparatus of claim 18, wherein if the first optical module emits the plurality of first direction lights simultaneously, the second optical module will receive the plurality of first direction lights sequentially.

22. The optical touch apparatus of claim 18, wherein the first optical module comprises a plurality of light guiding units, the second optical module comprises a plurality of receiving units, a first receiving unit of the plurality of receiving units corresponds to a first light guiding unit of the plurality of light guiding units and a first position, and the first receiving unit is used to receive a first direction light emitted from the first light guiding unit.

23. The optical touch apparatus of claim 22, wherein when the first direction light emitted from the first light guiding unit is blocked by the object, the photoelectric sensing module will sequentially receive other first direction lights of the plurality of first direction lights except the first direction light, and generate the first sensing result based on the receiving condition.

24. The optical touch apparatus of claim 18, further comprising:
a third optical module, set at a third side on the surface, for receiving a second light source and uniformly emitting a plurality of second direction lights; and
a fourth optical module, set at a fourth side opposite to the third side on the surface, for receiving the plurality of second direction lights;
wherein the photoelectric sensing module generates a second sensing result based on the condition of the fourth optical module receiving the plurality of second direction lights, the processing module determining the touch point location corresponding to the object on the surface based on the first sensing result and the second sensing result.

25. A method of operating an optical touch apparatus, the optical touch apparatus comprising a first optical module, a second optical module, and a processing module, the first optical module being set at a first side on a surface of the optical touch apparatus, the first light sensing module being set at a second side opposite to the first side on the surface, the method comprising the steps of:
the first optical module receiving a first light source and uniformly emitting a plurality of first direction lights;
the second optical module receiving the plurality of first direction lights;
when at least one of the plurality of first direction lights is blocked by an object above the surface, the photoelectric sensing module generating a first sensing result based on the condition of the second optical module receiving the plurality of first direction lights; and
the processing module determining a touch point location corresponding to the object on the surface based on the first sensing result.

26. The method of claim 25, wherein the photoelectric sensing module is a large-angle photoelectric sensing apparatus.

27. The method of claim 25, wherein if the first optical module emits the plurality of first direction lights sequentially, the second optical module will receive the plurality of first direction lights simultaneously or sequentially.

28. The method of claim 25, wherein if the first optical module emits the plurality of first direction lights simultaneously, the second optical module will receive the plurality of first direction lights sequentially.

29. The method of claim 25, wherein the first optical module comprises a plurality of light guiding units, the second optical module comprises a plurality of receiving units, a first receiving unit of the plurality of receiving units corresponds to a first light guiding unit of the plurality of light guiding units and a first position, and the first receiving unit is used to receive a first direction light emitted from the first light guiding unit.

30. The method of claim 29, wherein when the first direction light emitted from the first light guiding unit is blocked by the object, the photoelectric sensing module will sequentially receive other first direction lights of the plurality of first direction lights except the first direction light, and generate the first sensing result based on the receiving condition.

31. The method of claim 25, wherein the optical touch apparatus further comprises a third optical module and a fourth optical module, the third optical module is set at a third side on the surface, and the fourth optical module is set at a fourth side opposite to the third side on the surface, the method further comprises the steps of:
the third optical module receiving a second light source and uniformly emitting a plurality of second direction lights;
the fourth optical module receiving the plurality of second direction lights;
the photoelectric sensing module generating a second sensing result based on the condition of the fourth optical module receiving the plurality of second direction lights; and
the processing module determining the touch point location corresponding to the object on the surface based on the first sensing result and the second sensing result.

32. An optical touch apparatus, comprising an emitting module and a receiving module, the emitting module and the receiving module being set at a first side of a surface of the optical touch apparatus and a second side opposite to the first side respectively, the emitting module being used for uniformly emitting a plurality of lights, the receiving module being used for receiving the plurality of lights, at least one partial area of the emitting module and/or the receiving module being composed of an optical unit with a light guiding function.
